(19) United States
(12) Patent Application Publication
(10) Pub. No.: US 2013/0171413 A1
(43) Pub. Date: Jul. 4, 2013

(54) PROCESS FOR ALTERING THE WETTING PROPERTIES OF A SUBSTRATE SURFACE

(71) Applicants: Saif A. Khan, Singapore (SG); Mohammed Khalid Bin Dawood, Singapore (SG); Raj Rajagopalan, Singapore (SG); Wee Kiong Choi, Singapore (SG); Han Zheng, Singapore (SG)

(72) Inventors: Saif A. Khan, Singapore (SG); Mohammed Khalid Bin Dawood, Singapore (SG); Raj Rajagopalan, Singapore (SG); Wee Kiong Choi, Singapore (SG); Han Zheng, Singapore (SG)

(21) Appl. No.: 13/822,449

(22) PCT Filed: Sep. 13, 2011
(86) PCT No.: PCT/SG11/00312

§ 371 Date: Mar. 12, 2013

Related U.S. Application Data
(60) Provisional application No. 61/382,054, filed on Sep. 13, 2010.

(51) Int. Cl. B44C 1/22

(52) U.S. Cl. CPC B44C 1/227
USPC 428/141; 216/51

(57) ABSTRACT

Methods for altering the wetting property of the surface of a substrate are disclosed. The methods can include the step of
providing an array of nanostructures on the substrate, each nanostructure having a proximal end adjacent to the substrate and a distal end opposite to the proximal end. The methods can also include the step of moving the distal ends of at least one subset of the array of nanostructures towards each other to form at least one nanostructure cluster. The nanostructures of each cluster have distal ends that are spaced closer to each other relative to the respective proximal ends of the adjacent nanostructures, the nanostructure cluster altering the wetting property of the substrate.

### BACKGROUND OF THE INVENTION

1. Field of the Invention

The present invention relates to a process for altering the wetting properties of a substrate surface. The present invention also relates to a substrate having altered wetting properties, more particularly to a substrate surface that exhibits superhydrophobic properties and which may have both high or low adhesion properties.

2. Description of the Related Art

Nature presents us with at least two types of superhydrophobic surfaces: low-adhesion superhydrophobic surfaces, as observed in lotus leaves (lotus effect) ^{1,2} and the recently reported high-adhesion superhydrophobic surfaces as observed in some flower petals (petal effect) such as the red rose (rosea Rehd) and Rosa Hybrid Tea, cv. Bairage. The interesting wetting properties of these surfaces has prompted studies that attempt to artificially replicate these surfaces for a wide range of useful applications such as self-cleaning, anti-fog surfaces as well as for the possible applications in fluid drag reduction and humidity control for electronic devices, just to name a few.

The ability to artificially mimic the superhydrophobic properties of the lotus leaf has been of great interest due to wide range of applications such as self-cleaning surfaces and anti-fog surfaces. The discovery of high-adhesion superhydrophobic properties of certain petals has sparked new interest in the study of surface wetting and the possible applications for such surfaces. Though there have been numerous examples of artificially mimicking the lotus effect and recently some examples of mimicking the petal effect, there has been no demonstration of (i) obtaining both types of surfaces simultaneously using a single process and (ii) the ability to integrate both types of surfaces onto one surface.

Until now, a method to fabricate superhydrophobic surfaces with tunable adhesion, on a single substrate had proved difficult. This is primarily due to the significantly different and independent fabrication techniques required for fabricating a petal-like and lotus-like surface. The most common method to fabricating a superhydrophobic surface is first to increase the surface roughness of a given substrate and to subsequently reduce the surface energy by coating the surface with a material of low surface energy, such as an organosilane. The majority of artificially fabricated superhydrophobic surfaces on Si or quartz substrates typically require (i) a lithography process for the patterning of ordered micro- and/or nanostructures (ii) and/or an etching process (such as RIE) or (iii) a deposition or growth process (such as the deposition of silica nanoparticles or growth of carbon nanotubes) to achieve the required surface roughness, followed by a silanization process.

Accordingly, there is a need for an improved method for fabricating superhydrophobic surfaces with tunable adhesion on a single substrate.

### BRIEF SUMMARY OF THE INVENTION

According to a first aspect, there is provided a process for altering the wetting property of the surface of a substrate, the process comprising the steps of:
(a) providing an array of nanostructures on the substrate, each nanostructure having a proximal end adjacent to the substrate and a distal end opposite to said proximal end; and
(b) moving the distal ends of at least one subset of said array of nanostructures towards each other to thereby form at least one nanostructure cluster, wherein the nanostructures of each cluster have distal ends that are spaced closer to each other relative to the respective proximal ends of said adjacent nanostructures, said nanostructure cluster altering the wetting property of the substrate.

Advantageously, by forming clusters of nanostructures on the surface of the substrate, it is possible to alter the wetting properties of the substrate surface. When an array of clusters are arranged on the surface, the nanowires within the cluster are “bunched” together and, due to the dimension of the cluster, tend to increase the overall hydrophobicity of the substrate relative to the hydrophobicity of a substrate without nanostructures.

The process may further comprise the steps of:
(a) providing the nanostructures in a liquid medium, wherein the distal ends of adjacent nanostructures are about the same distance as that of the adjacent proximal ends; and
(b) removing the liquid medium from the nanostructures to move the distal ends of adjacent nanostructures towards each other and thereby form the at least one cluster thereon.

Advantageously, the dimension of the nanostructures causes them to be relatively flexible and hence when in solution after being formed, they tend to stand such that the longitudinal axis of the nanostructures is about normal relative to the substrate. However, as the liquid medium is removed, such as by evaporation, the nanostructures that are adjacent to each other tend to collapse against each other by a capillary coalescence affect of the evaporating liquid medium.

The removing step may comprise the step of adjusting the rate of removal of the liquid medium to alter the dimensions of the formed cluster. The liquid medium may be an aqueous medium such as water. The liquid medium may have a higher volatility relative to water such as alcohol. Indeed, the liquid medium may in fact be a combination of water and alcohol. Advantageously, it is possible to alter the dimension of the cluster formed by altering the rate of evaporation of the liquid medium. In this regard, if water is used then the rate of evaporation is less than that of alcohol and hence the resulting cluster formed on the surface tends to be smaller relative to clusters that have formed by evaporation of a more rapid alcohol solution. Accordingly, it is possible to tune or tailor the relative dimension of the formed cluster by the rate of removal of the liquid medium which be done by the evaporation rate of the liquid medium. The evaporation rate of the liquid medium may be manipulated therefore by the choice of media or by selection of the pressure under which the liquid medium evaporated. Accordingly, in another embodiment, the rate of removal of the liquid medium is adjusted by the pressure under which the liquid medium is removed from the substrate. In yet another embodiment, the rate of removal of the liquid medium is adjusted by the temperature under which the liquid medium is removed from the substrate.

The step of providing the array of nanostructures on the substrate may comprise the step of interspacing adjacent nanostructures at unequal distances from each other.

The step of providing the array of nanostructures on the substrate may comprise the step of providing said nanostructures of unequal width dimensions.

In one embodiment, the step of providing the array of nanostructures on the substrate comprises the step of selectively etching the substrate. The substrate may be catalytically etched. Before the selectively etching step, the process may comprise depositing a plurality of catalyst particles on the substrate. The etching step may comprise etching the substrate in contact with said catalyst particles at a faster rate relative to the substrate surface not in contact with the catalyst particles.

In an embodiment, there is provided the process as defined above, wherein the providing step comprises forming the nanostructures on the substrate using a glancing angle deposition technique.

In an embodiment, there is provided the process as defined above, wherein the catalyst particles have different dimensions.

The process may comprise the step of functionalizing the nanostructures with a compound to increase the hydrophobicity of the surface of the nanostructures. The functionalizing step may comprise functionalizing the surface of the substrate with an organosilane group.

The dimension of said at least one nanostructure cluster may be varied in order to tune the wetting property of the substrate surface.

The process may be used in combination with a process for producing hydrophilic surfaces on a substrate.

In a second aspect, there is provided a substrate comprising at least one nanostructure cluster thereon, said nanostructure cluster comprising plural nanostructures, each nanostructure having a proximal end adjacent to said substrate and a distal end opposite to said proximal end, wherein the nanostructures of each cluster have distal ends that are spaced closer to each other relative to their respective proximal ends of said adjacent nanostructures.

The distal ends of the adjacent nanostructures may abut each other to form said cluster. Plural clusters on the substrate may alter the wetting property of the substrate. The plural clusters may render the substrate more hydrophobic relative to a substrate that is without the clusters.

The surface of the nanostructures may have a hydrophobic compound thereon which may be an organosilane functional group.

The distance between at least two pairs of nanostructures in a cluster may be unequal. The dimension of said at least one cluster may be in the micro-size range.

The at least one cluster may have a dimension in the range of 1 micron to 5 micron.

The cluster may be generally cone shaped.

In an embodiment, there is provided a substrate as defined above, wherein the distance between adjacent clusters in an array of clusters is in the range of 100 nm to 10 μm.

In a third aspect, there is provided a substrate having an array of nanostructures thereon, each nanostructure having a proximal end adjacent to said substrate and a distal end opposite to said proximal end, wherein the substrate has a cluster part comprising at least one cluster of nanostructures having distal ends that are spaced closer to each other relative to the respective proximal ends of said adjacent nanostructures, and a non-cluster part comprising nanostructures having distal ends that are spaced about the same relative to the respective proximal ends of said adjacent nanostructures.

In an embodiment, there is provided a substrate as defined above, wherein plural cluster parts and non-cluster parts are provided thereon.

The following words and terms used herein shall have the meaning indicated:

The terms “hydrophilic” or “hydrophilicity”, when referring to a surface, are to be interpreted broadly to include any property of a surface that causes a water droplet to substantially spread across it. Generally, if the contact angle between a water droplet and the surface is smaller than 90°, the surface is hydrophilic or exhibits hydrophilicity. The water droplet may be replaced with any liquid that is miscible with water. Accordingly, the contact angle between a liquid miscible with water and a hydrophilic surface is also smaller than 90°. Exemplary liquids that are miscible with water are ethanol, acetone and tetrahydrofuran. The term “superhydrophilic” refers to when the contact angle between a water droplet and the surface is smaller than 5°.

The terms “hydrophobic” and “hydrophobicity”, when referring to a surface, are to be interpreted broadly to include any property of a surface that does not cause a water droplet to substantially spread across it. Generally, if the contact angle between a water droplet and the surface is greater than 90°, the surface is hydrophobic or exhibits hydrophobicity. The water droplet may be replaced with any liquid that is miscible with water. Accordingly, the contact angle between a liquid miscible with water and a hydrophobic surface is also greater than 90°. Exemplary liquids that are miscible with water are ethanol, acetone and tetrahydrofuran. The term “superhydrophobic” refers to when the contact angle between a water droplet and the surface exceeds 150° and the roll-off angle is less than 10°.

The term “hysteresis” or “contact angle hysteresis” refers to the difference between advancing contact angle and receding contact angle. Advancing contact angle is defined as the contact angle just before the contact line advances as water is dispensed on the surface. Similarly, the receding contact angle is defined as the contact angle just before the contact line recedes as water is withdrawn from the surface.

The term “high-adhesion” when referring to a substrate surface is to be interpreted broadly to include any surface that is able to retain or pin a liquid droplet on the substrate surface, despite the hydrophobicity of the substrate surface. This property of the substrate is also known as the “petal-effect”.

The term “low-adhesion” when referring to a substrate surface is to be interpreted broadly to include any surface that is not able to retain a liquid droplet thereon and the liquid merely flows off the substrate surface. This property of the substrate is also known as the “lotus effect”.

The term “contact angle”, in the context of this specification, is to be interpreted broadly to include any angle that is measured between a liquid/solid interface. The contact angle is system specific and depends on the interfacial surface tension of the liquid/solid interface. A discussion on contact angle and its relation to surface wetting properties can be seen from “Wettability, Spreading, and Interfacial Phenomena in High-Temperature Coatings” by R. Asthana and N. Sobczak, JOM-e, 2000, 52 (1). The contact angle can be measured from two directions. In the context of this specification, for a longitudinal imprint being disposed about a longitudinal axis, θx refers to the contact angle measured in the “X” direction being perpendicular to the longitudinal axis and θy refers to the contact angle measured in the “Y” direction parallel, or in alignment with, the longitudinal axis. The value of the contact angle, θx or θy, may indicate the hydrophobicity or hydrophilicity of a surface. The difference of these two contact angles, represented by Δθ (where Δθ=θy−θx), indicates the degree of isotropy or anisotropy of a wetting property.

The term “nanoparticle” refers to a particle with a particle size in the nano-sized range. The particle size may refer to the diameter of the particles where they are substantially spherical. The particles may be non-spherical and the particle size range may refer to the equivalent diameter of the particles relative to spherical particles or may refer to a dimension (length, breadth, height or thickness) of the non-spherical particle.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF THE SEVERAL VIEWS OF THE DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram illustrating the basic processes utilized in the GLAD-CE process to fabricate silicon nanowires followed by silanization of the nanowires to achieve superhydrophobicity.

FIG. 2a is a Scanning Electron Microscope (SEM) image of gold nanoparticles deposited on silicon via GLAD for 30 minutes. FIG. 2b is a SEM image of gold nanoparticles deposited on silicon via GLAD for 90 minutes. FIG. 2c is an enlarged image of FIG. 2b showing the presence of a high density of smaller gold nanoparticles (as depicted by the arrows) between the larger silver nanoparticles. FIG. 2d is a histogram showing the distribution of gold nanoparticles from SEM images similar to FIG. 2a and FIG. 2b.

FIG. 3a is a SEM image of nanowires from etching silicon with gold nanoparticles of unimodal size distribution. The inset is a top view SEM image of the sample with a scale bar of 10 μm. FIG. 3b is a SEM image of nanowires catalytically etched from silicon with gold nanoparticles of bimodal size distribution. The inset is a top view SEM image of the sample with a scale bar of 10 μm. FIG. 3c is a cross-sectional SEM image of the nanowires of FIG. 3a. The inset, with a scale bar of 300 nm, shows the presence of gold nanoparticles that have “sunk” to the bottom of the silicon surface. FIG. 3d is a cross-sectional SEM image of the nanowires of FIG. 3b. The inset, with a scale bar of 500 nm, shows the presence of gold nanoparticles that have “sunk” to the bottom of the silicon surface. FIG. 3e is a Transmission Electron Microscopy (TEM) image of the silicon nanowires of FIG. 3a. FIG. 3f is a Transmission Electron Microscopy (TEM) image of the silicon nanowires of FIG. 3b.

FIG. 4a shows a 4 μl droplet of water on the CNS which remains attached to the syringe. FIG. 4b shows a 6 μl drop on water on the CNS. FIG. 4c shows a 4 μl droplet of water on the NCNS. FIG. 4d shows a 4 μl droplet on the NCNS at a tilting angle of 180°. FIGS. 4e (1 to 4) is a series of snapshot images of water droplets impinging on the CNS while FIGS. 4e (5 to 8) is a series of snapshot images of water droplets impinging on the NCNS. FIG. 4f compares the contact angle measurements obtained from the CNS and the NCNS with the Cassie-Baxter equation.

FIG. 5a is a picture of a silicon sample that is fabricated with both CNS (outside the squares) and NCNS (within the squares). A droplet of water is shown in this figure pinned within a square containing NCNS. FIG. 5b shows the droplet pinned to surface when the silicon sample is tilted upside down. FIG. 5c is a low magnification SEM image of the square containing the non-clumped nanowires. FIG. 5d is a high magnification SEM image of FIG. 5b showing the different morphology of the nanowires within and outside of the defined squares. FIG. 5e is a schematic diagram that illustrates the process flow to obtain the tunable adhesion superhydrophobic surface of FIG. 5a.

FIG. 6a is a SEM image at low magnification of a silicon surface having two different wetting properties. Here, a SiO₂ square surrounded by CNS is shown. FIG. 6b is a high magnification SEM image showing the CNS around the SiO₂ surface. FIG. 6c is a schematic diagram that illustrates the process flow to obtain the silicon surface of FIG. 6a with dual hydrophobic-superhydrophobic wetting properties. FIG. 6d is a photograph illustrating small drops of water wetting the hydrophilic surface only after immersion in water.

FIG. 7a is a top-view SEM image showing the silicon nanowires after drying in water. FIG. 7b is a top-view SEM image showing the silicon nanowires after drying in 2-propanol. FIG. 7c is a top-view SEM image showing the silicon nanowires after drying in methanol. FIG. 8 is a histogram of solid fraction f, representing the fraction of the surface comprised by the solid, which was estimated from digitally analyzing the SEM images similar to FIG. 7a, FIG. 7b and FIG. 7c.

FIG. 9a, FIG. 9b and FIG. 9c show the percolation of the sample that corresponds to FIG. 7a, FIG. 7b and FIG. 7c respectively. In all of these figures, the top image represents the digitized SEM image selecting only the tips of the nanowire clusters while the coloured images show the degree of percolation between the respective nanowires samples.

FIG. 10a, FIG. 10b and FIG. 10c show the contact angle measures on the sample that corresponds to FIG. 7a, FIG. 7b and FIG. 7c respectively.

FIG. 11 is a graph showing that the contact measurements on the different nanowire surfaces of FIG. 7a, FIG. 7b and FIG. 7c follow the prediction of the Cassie-Baxter equation quite closely.

FIG. 12a shows the top-view SEM image of GLAD-CE nanowires after critical point drying while FIG. 12b is a cross-sectional SEM image of the same sample. FIG. 13a is a schematic diagram showing GLAD-CE nanowire arrays being partially dried in water and methanol. FIG. 13b is a series of SEM images showing the difference in cluster size when moving from the b(i) water-dried region, b(ii) the boundary between the water-dried and methanol-dried regions, and b(iii) methanol-dried region.

FIG. 14a is a schematic diagram showing the steps involved when drying in more than one solvent. FIG. 14b shows the different nanowire morphologies along the length of the sample showing the distinct clustering of nanowires due to the different drying processes.

FIG. 15a is a graph of the CA measurements with varying metal-assisted CE durations at different GLAD durations.

FIG. 15b are SEM images of the sample carried out at 100 minutes GLAD duration etched for b(i) 2, b(ii) 4, b(iii) 10, and b(iv) 20 minutes. FIG. 15c are SEM images showing the silicon nanowire arrays with varying morphologies obtained by the metal-assisted CE of silicon for 20 minutes with increasing GLAD duration: c(i) 17 minutes, c(ii) 33 minutes, c(iii) 67 minutes, and c(iv) 100 minutes.

### DETAILED DESCRIPTION OF THE INVENTION

Exemplary, non-limiting embodiments of a process for altering the wetting properties of a substrate will now be disclosed, which includes fabricating high and low-adhesion superhydrophobic surfaces on nanostructured substrates.

The disclosed process may comprise the step of producing nanostructure arrays on a substrate. The process may comprise the step of producing clumped structures using said nanostructures. The nanostructure arrays may be fabricated by metal-assisted catalytic etching (CE) of the substrate in an etching solution with the aid of catalyst particles, such as metal nanoparticles that may be deposited on the substrate by means of an oblique-angle deposition (also known as glancing-angle deposition or GLAD) process. The combination of GLAD and CE is hereby termed as “GLAD CE”. The metal nanoparticles may act as catalysts in the etching of the substrate beneath them. Thus, when subjected to CE, the substrate surface in contact with the catalyst particles is etched away at a faster rate relative to the substrate surface not in contact with the catalyst particles. As a result, nanostructures may be formed from the substrate surface which is not in contact with the catalyst particles.

The substrate may be glass, carbon, silicon (Si), SiGe, GaN, SiC and GaAs. For the carbon based substrate, the etching method should be plasma etching using argon and/or oxygen as the etching gases. In one embodiment, silicon is used as the substrate

The disclosed method may comprise the following steps. The substrate may be cleaned in order to remove any impurities that may interfere with the subsequent steps. The substrates may then be subjected to an etching step in an acidic solution prior to the GLAD step. The etching step may be carried out for a period selected from the group consisting of about 30 seconds to about 5 minutes, about 1 minute to about 5 minutes, about 2 minutes to about 5 minutes, about 3 minutes to about 5 minutes, about 4 minutes to about 5 minutes, about 30 seconds to about 1 minute, about 30 seconds to about 2 minutes, about 30 seconds to about 3 minutes and about 30 seconds to about 4 minutes. In one embodiment, the etching step may be carried out for about 1 minute when HF is used as the acidic solution.

The GLAD step should be carried out under conditions in which the vapor flux arrives at the substrate in approximately a straight line. For this reason, this step is preferably carried out under conditions approximating a vacuum, at a pressure less than 10^{˜3} torr, or less than 10^{˜6} torr. In order to achieve this pressure, the GLAD step may be carried out in an electron beam evaporator. At higher pressures, scattering from gas molecules present in the evaporator tends to prevent well defined nanoparticles from growing. In addition, the substrate used should have a sticking co-efficient of at least about 0.9 to enable the formation of distinct nanoparticles.

The substrate normal may be placed at an angle selected from the range of about 85° to about 90°, about 85° to about 86°, about 85° to about 87°, about 85° to about 88°, about 85° to about 89°, about 86° to about 90°, about 87° to about 90°, about 88° to about 90° and about 89° to about 90° to the direction of the incoming flux. In one embodiment, the angle may be about 87°. It is to be noted that the angle of deposition should be chosen to allow the deposit of discrete catalyst particles and not a film of catalyst particles. Accordingly, a deposition angle of less than about 80° should be avoided.

The substrate may be rotated at a rate selected from the group consisting of about 0.01 rpm to about 10 rpm, about 1 rpm to about 10 rpm, about 2 rpm to about 10 rpm, about 3 rpm to about 10 rpm, about 4 rpm to about 10 rpm, about 5 rpm to about 10 rpm, about 6 rpm to about 10 rpm, about 7 rpm to about 10 rpm, about 8 rpm to about 10 rpm, about 9 rpm to about 10 rpm, about 2 rpm to about 3 rpm, about 2 to about 4 rpm, about 2 rpm to about 5 rpm, about 2 rpm to about 6 rpm, about 2 rpm to about 7 rpm, about 3 rpm to about 8 rpm, about 2 rpm to about 9 rpm, about 3 rpm to about 4 rpm, about 3 rpm to about 5 rpm, about 3 rpm to about 6 rpm, about 3 rpm to about 7 rpm, about 3 rpm to about 8 rpm, about 3 to about 9 rpm, about 4 rpm to about 5 rpm, about 4 rpm to about 6 rpm, about 4 rpm to about 7 rpm, about 4 rpm to about 8 rpm, about 4 rpm to about 9 rpm, about 5 rpm to about 6 rpm, about 5 rpm to about 7 rpm, about 5 rpm to about 8 rpm, about 5 rpm to about 9 rpm, about 6 rpm to about 7 rpm, about 6 rpm to about 8 rpm, about 6 rpm to about 9 rpm, about 7 rpm to about 8 rpm, about 7 rpm to about 9 rpm, about 8 rpm to about 9 rpm, about 0.1 rpm to about 1 rpm, about 0.5 rpm to about 1 rpm and about 0.1 rpm to about 0.3 rpm. In one embodiment, the rotational rate of the substrate may be about 0.2 rpm.

The catalyst particles may be selected from the group consisting of Au, Ag, Pt, Pd and Cu. In one embodiment, the catalyst particles are Au nanoparticles. The etching solution may comprise of HF and an oxidizing agent which may be selected from, but not limited to, AgNO₃, KMnO₄ and Fe(NO₃)₃. In one embodiment, H₂O₂ is used. For the carbon based substrates, the etching method should be plasma etching using argon and/or oxygen as the etching gases.

In one embodiment, gold (Au) nanoparticles may be deposited on a Si substrate via GLAD and used as catalysts in the CE step to etch silicon (Si) with an etching solution comprising of H₂O, H₂O₂ and HF. The Au nanoparticles may facilitate the reduction of H₂O₂, resulting in the generation of holes, which get injected into the Si via the Au nanoparticles. This injection of holes in turn may facilitate the etching of Si by HF. Hence, the Si in the vicinity of the Au nanoparticles may be etched away, causing a collective sinking of the Au nanoparticles into the Si. As a result of the dense network of Au nanoparticles on Si generated by the GLAD step and the sinking of the Au nanoparticles into the Si, freestanding nanostructures remain after the GLAD CE process.

In the disclosed process, the duration of the GLAD step may be in the range selected from the group consisting of about 15 minutes to about 100 minutes, about 30 minutes to about 100 minutes, about 45 minutes to about 100 minutes, about 60 minutes to about 100 minutes, about 75 minutes to about 100 minutes, about 90 minutes to about 100 minutes, about 15 minutes to about 30 minutes, about 15 minutes to about 45 minutes, about 15 minutes to about 60 minutes, about 15 minutes to about minutes, about 15 minutes to about 90 minutes and about 30 minutes to about 90 minutes. In one embodiment, the duration of the GLAD step may be about 30 minutes, or about 90 minutes. In a process in which more than one GLAD step is required, the time taken for each GLAD step may be the same or may be different from each other. Here, a GLAD step may be undertaken for about 30 minutes while the other GLAD step may be undertaken for about 90 minutes. It is to be noted that the longer the duration of the GLAD step, more and bigger catalyst particles may be deposited on the substrate. Due to the different amount and size of the catalyst particles deposited, the porosity, particle size distribution and extent of clumping of the resultant nanostructures may be altered or substantially controlled.

The catalyst particles may be deposited as discrete particles, rather than a continuous thin film of catalyst particles. Hence, the diameter (if the catalyst particles are substantially spherical) or equivalent diameter (if the catalyst particles are substantially non-spherical) of the catalyst particles deposited may be selected from the group consisting of about 1 nm to about 100 nm, about 20 nm to about 100 nm, about 40 nm to about 100 nm, about 60 nm to about 100 nm, about 80 nm to about 100 nm, about 1 nm to about 20 nm, about 1 nm to about 40 nm, about 1 nm to about 60 nm, about 1 nm to about 80 nm, about 20 nm to about 40 nm, about 30 nm to about 40 nm, about 1 nm to about 3 nm and about 11 nm to about 13 nm. In one embodiment, the diameter of the catalyst particles is about 3 nm or about 12 nm. The dimensions of the catalyst particles may be equal to each other or may be different. The process may comprise, after the GLAD step, the step of catalytically etching the substrate. The duration of the chemical etching step may be selected from the group consisting of about 5 minutes to about 30 minutes, about 10 minutes to about 30 minutes, about 15 minutes to about 30 minutes, about 20 minutes to about 30 minutes, about 25 minutes to about 30 minutes, about 5 minutes to about 10 minutes, about 5 minutes to about 15 minutes, about 5 minutes to about 20 minutes, about 5 minutes to about 25 minutes, about 10 minutes to about 15 minutes, about 10 minutes to about 20 minutes, about 10 minutes to about 25 minutes, about 15 minutes to about 20 minutes, about 15 minutes to about 25 minutes and about 19 minutes to about 21 minutes. In one embodiment, the CE step is carried out for about 20 minutes.

After the CE step, nanostructures may be viewed on the surface of the substrate. The nanostructures may be nanocolumns, nanopillars or nanowires. In one embodiment, the nanostructures are nanowires. The thickness of the nanostructures may be selected from the group consisting of about 10 nm to about 100 nm, about 20 nm to about 100 nm, about 30 nm to about 100 nm, about 40 nm to about 100 nm, about 50 nm to about 100 nm, about 60 nm to about 100 nm, about 70 nm to about 100 nm, about 80 nm to about 100 nm, about 90 nm to about 100 nm, about 10 nm to about 20 nm, about 10 nm to about 30 nm, about 10 nm to about 40 nm, about 10 nm to about 50 nm, about 10 nm to about 60 nm, about 10 nm to about 70 nm, about 10 nm to about 80 nm and about 10 nm to about 90 nm.

The length of the nanostructures may be selected from the group consisting of from about 10 nm to about 20 nm, about 12 nm to about 20 nm, about 14 nm to about 20 nm, about 16 nm to about 20 nm, about 18 nm to about 20 nm, about 10 nm to about 12 nm, about 10 nm to about 14 nm, about 10 nm to about 16 nm, about 10 nm to about 18 nm, about 12 nm to about 14 nm, about 12 nm to about 16 nm, about 12 nm to about 18 nm, about 12 nm to about 20 nm, about 14 nm to about 16 nm, about 14 nm to about 18 nm, about 14 nm to about 20 nm, about 16 nm to about 18 nm and about 14.5 nm to about 15.5 nm. In one embodiment, the length of the nanostructures may be about 15 nm.

The distance between each nanostructure may be equal or may vary.

The nanostructures may extend from the surface of the substrate such that they do not substantially contact or touch each other at any point along their longitudinal axes. Alternatively, more than one nanostructures may come towards each other and clump together, typically at the ends of the nanostructures.

It is to be noted that the ability of nanostructures to capture liquid on the surface of the substrate (that is, the level of adhesion of the nanostructures) may depend on the extent of clumping of the nanostructures.

The catalyst particles on the substrate may then be removed using standard commercially available etchants.

The substrate may then be subjected to another etching step to remove any native oxide before the nanostructures are functionalized with a compound to increase the hydrophobicity of the surface of the nanostructures. The etching solution used may be an acidic solution. The etching step may be carried out for a period selected from the group consisting of about 30 seconds to about 5 minutes, about 1 minute to about 5 minutes, about 2 minutes to about 5 minutes, about 3 minutes to about 5 minutes, about 4 minutes to about 5 minutes, about 30 seconds to about 1 minute, about 30 seconds to about 2 minutes, about 30 seconds to about 3 minutes and about 30 seconds to about 4 minutes. In one embodiment, the etching step may be carried out for about 1 minute when HF is used as the acidic solution.

The aforementioned functionalizing step may be a silanization step, which may involve, for example, placing the substrates in a desiccator for a period of time under conditions with an organosilane solution to ensure monolayer coverage. The organosilane solution may be selected from the group consisting of heptadecafluorodecyltrichlorosilane, perfluorooctyltriclorosilane, tetrahydrooctyltrichlorosilane heptadecafluorodecyltrimethoxysilanem, Trichloro (1H,1H,2H,2H-perfluorooctyl)silane (PF) and perfluorododecyltrichlorosilane. In one embodiment, the silanization step may be undertaken for about 12 hours under house vacuum (mTorr) with 6 μl of tridecafluoro-(1,1,2,2 tetrahydrooctyl)trichlorosilane. After silanization, the substrate (with the nanostructures extending from the surface thereon) has acquired a superhydrophobic nature.

The disclosed process then results in the formation of a substrate with a plurality of nanostructures extending from the surface thereon. Due to the silanization treatment, the substrate is superhydrophobic in nature. The process may also allow the fabrication of a substrate in which the nanostructures may be able to retain liquid thereon (high adhesion) or allow the liquid to slide off the surface (low adhesion). The nanostructures with the different adhesion properties may be disposed on the same substrate.

The morphology of the nanostructures may be tunable which may allow the fabrication of either High or Low-adhesion superhydrophobic surfaces on a single substrate surface. High-adhesion superhydrophobic surfaces result from non-clumped nanostructure surfaces (NCNS) whereas low-adhesion superhydrophobic surfaces result from clumped nanostructure surfaces (CNS).

In order for the nanostructures to cluster together and remain clustered, the capillary force exerted between the nanostructures needed to be larger than the bending force required to sufficiently bend the nanostructures to cause cohesion. In addition, for the nanostructures to remain clustered, the short-ranged van der Waals forces between the nanostructures needed to be larger than the bending force. The size of a cluster depends on the balance of the three forces at work. The net cluster size, N (average number of nanostructures per cluster), based on static energy minimization is represented as

$$N \sim \frac{{E}_{C}}{{E}_{E} } \sim \frac{{yh}^{3} {cos}^{2} {θ}_{0}}{{{D}^{2} ( p - D )}^{2} E} \qquad ( 1 )$$

where E_{C} is the capillary interaction energy, E_{E} is the elastic energy term, h is the height of the nanostructures, γ is the surface tension of the liquid, θ₀ is Young's angle (contact angle of liquid on flat surface), p is the distance between nanostructures and D is the diameter of the nanostructure.

The capillary force exerted between two nanostructures by surface tension is related to the surface tension, γ₁ₐ, and Young's angle, θ₀, as follows,

$$\text{?} = 2 π \text{?} {R}^{2} \frac{{cos}^{2} ( {θ}_{0} ) 1}{\sqrt{d ( 4 R + d )}} \\ \text{?} \text{indicates text missing or illegible when filed} \qquad ( 2 )$$

where R is the nanostructure radius and d is the distance between nanostructures.

In addition, if one models the nanostructure as a cantilever beam fixed at one end, a force exerted at the free end of the beam results in the largest deflection, i.e., the nanostructures experience the largest deflection when the liquid meniscus is at the tips of the nanostructures. The elastic force required to bend the nanostructures is given by

$$\text{?} = \frac{\text{?} π \text{?} \text{?} δ}{4 \text{?}} , \\ \text{?} \text{indicates text missing or illegible when filed} \qquad ( 3 )$$

where E is the Young's modulus, L the height of nanostructure and δ the deflection of the nanostructure.

Cassie-Baxter wetting state that explained water drops sitting on a ‘pin-cushion’ of nanostructures and does not penetrate into the nanostructures. This model is valid when the contact angle δ₀ on a smooth surface of the same material is greater than 90° (note that θ₀ was measured on a smooth silanized Si surface to be ˜120°. The contact angle θ* on the textured surface is given as

cos θ*=−1+f(cos θ₀+1) (4)

where f represents the solid fraction of the surface.

Advantageously, the fabrication of either CNS or NCNS may be controlled by the duration of the GLAD step. By performing a longer GLAD step, larger catalyst particles are deposited on the substrate. When the chemical etching step is subsequently performed, this results in nanostructures which bend to form pronounced clumps (clusters) thereby producing CNS. Conversely, by performing a shorter GLAD step, smaller catalyst particles are deposited on the substrate. Following the etching process, this results in straighter nanostructures, thereby producing NCNS. Hence, the different dimensions of the catalyst particles forms nanostructures of different size dimensions that are interspaced differently from each other and these differences in turn affect the dimensions of the clusters formed.

The size of the clusters may vary from each other and may be in the micro-size range. For example, the size of the clusters may be in the range of about 1 μm to about 5 μm. The distance between each cluster may be selected from the group consisting of about 100 nm to about 10 μm, about 100 nm to about 500 nm, about 500 nm to about 1 μm, about 1 μm to about 5 μm, about 5 μm to about 10 μm, about 100 nm to about 1 μm, about 1 μm to about 10 μm, about 500 nm to about 5 μm and about 500 μm to about 10 μm.

Both high and low-adhesion superhydrophobic surfaces may be produced on a single substrate by controlling the clustered and non-clustered areas of nanostructures on a substrate. This can be achieved by controlling the size and position of catalyst particles deposited during the GLAD process by appropriate masking techniques.

Both high and low-adhesion superhydrophobic surfaces may be produced on a single substrate by compartmentalizing the substrate such that the GLAD CE process is only carried out on specific areas of the substrate. For example, various materials can be used to cover a particular area on the substrate so that the GLAD process does not result in the deposition of catalyst particles on said area. In this manner, the size and position of the catalyst particles can be controlled. Hence, the substrate will possess a combination of cluster parts and non-cluster parts.

In one embodiment, both high and low-adhesion superhydrophobic surfaces are produced on a single Si substrate by first patterning photoresist on the Si substrate by using conventional photolithography with a transparency mask. Next a GLAD step is performed to deposit Au nanoparticles with the bimodal size distribution (that is, the Au nanoparticles have a wide particle size distribution). The photoresist is removed and, in doing so, the Au deposited on the photoresist is lifted off. A second GLAD step is then performed. The duration of the second GLAD process is controlled such that it results in the deposition of the Au nanoparticles with a unimodal size distribution (that is, the Au nanoparticles have a narrow particle size distribution)on the Si surface that was previously patterned with photoresistive material. The Si is then catalytically etched and silanized as described above.

Advantageously, the fabrication of either CNS or NCNS may also be controlled by exploiting capillary-force-induced nanocohesion by drying the substrate after the GLAD CE steps in different liquid media such as solvents and alcohols. Examples of solvents and alcohols which may be used include but are not limited to deionized water, ethanol, 2-propanol, butanol and methanol.

Advantageously, the use of different liquid media allows the degree of aggregation of the nanostructures to be tuned in order to obtain different morphologies. This may be achieved by varying the rate of removal of the liquid medium. For example, a slower rate of removal of the liquid medium (which depends on the volatility of the liquid medium) will result in smaller clusters being formed while conversely a more rapid rate of liquid medium removal will result in larger clusters forming. Advantageously, water tends to form smaller clusters relative to more volatile media such as alcohols due to the slower rate of evaporation at the same temperature and pressure. The temperature and pressure at which the liquid medium is removed may also be altered.

The substrates are typically dried until the liquid media evaporates substantially completely. Typically, the substrate is left to dry overnight.

In one particular embodiment, CNS is fabricated by drying the substrate in methanol, whilst NCNS is fabricated by drying the substrate in deionized water.

Both high and low-adhesion superhydrophobic surfaces may be produced on a single substrate by drying specific areas of the substrate in different liquid media. This may be done for example in the following fashion. The GLAD CE steps as described above are first carried out. Immediately following the GLAD CE steps, the substrate is rinsed in copious amounts of deionized water. Next, the substrate is withdrawn and partially immersed in an alcohol whilst still being wet. The part of the substrate not in alcohol remains wet with water and is left exposed to the air. The substrate is then left to dry until the alcohol evaporates.

More advantageously, the disclosed method may also allow the fabrication of hybrid surfaces with tunable adhesion (high and low adhesion superhydrophobic surfaces) and with hybrid wetting properties (i.e. both hydrophilic and superhydrophobic). This can be achieved for example by using commonly used techniques such as photolithography to produce hydrophilic areas on the substrate and using the disclosed process to produce the high and/or low-adhesion superhydrophobic surfaces on the remaining parts of the substrate.

In an exemplary embodiment, SiO₂ is first thermally grown on the substrate by thermal oxidation. Next, photolithography is used to pattern hydrophilic areas on the substrate. The exposed oxide was then etched in 10% HF solution. Next, photoresist is placed on the exposed oxide. This was followed by a GLAD step to obtain bimodal size distributed Au nanoparticles. Next catalytic etching was performed for 20 min. The Au nanoparticles were then removed by using a commercial Au etchant. The surface was then subjected to a silanization process, thereby producing a superhydrophobic surface. Finally, the photoresist on top of the oxide squares was removed by immersing the substrate in acetone, thereby producing a hydrophilic surface.

Advantageously, the disclosed method may be entirely scalable over large areas (up to entire 4″ wafers or more) and may not require complex lithography (such as electron-beam lithography) and etching processes (such as deep-RIE), which are synonymous with conventional top-down nanofabrication.

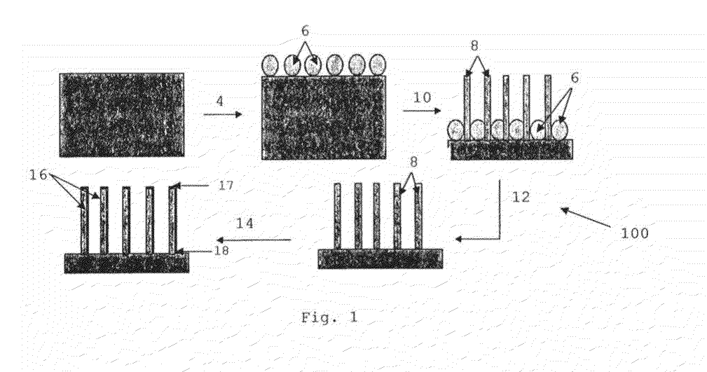

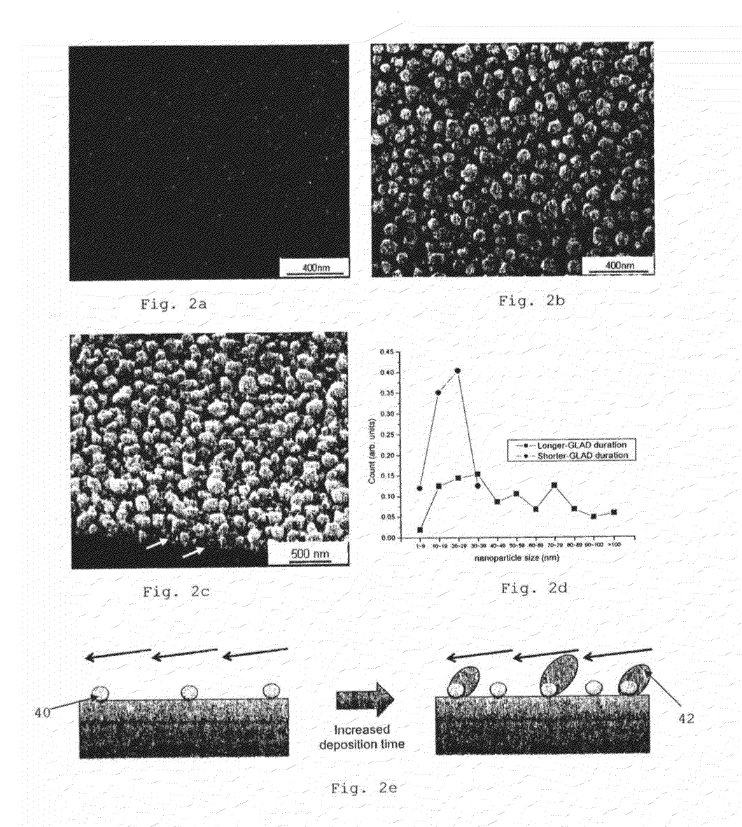

Referring to FIG. 1, there is shown a process 100 for forming a superhydrophobic silicon surface. A silicon wafer 2 was first cleaned by standard RCA1 (in which the silicon wafer 2 is cleaned in a solution of H₂O, H₂O₂ and NH₄OH) and RCA2 (in which the silicon wafer 2 is cleaned in a solution of H₂O, H₂O₂ and HCl) processes. The silicon wafer 2 was subjected to an etching solution for a period of time prior to loading into an electron-beam evaporator (not shown). The chamber of the electron-beam evaporator was pumped down to an appropriate pressure before commencing a GLAD step 4. GLAD involves the use of an electron source to melt and evaporate the gold wire, which is used as the source for depositing the gold on the silicon wafer 2. During the GLAD step 4, the substrate normal of the silicon wafer 2 was placed at an angle to the direction of the incoming flux and the silicon wafer 2 was rotated. Metal catalysts in the form of gold nanoparticles 6 were deposited on the surface of the silicon wafer 2 during the GLAD step 4.

The silicon wafer 2 was then subjected to a metal assisted catalytic etching step 10 by using an etching solution including hydrogen, HF and water peroxide. During this step, the gold nanoparticles 6 acted as catalysts that facilitated the reduction of the hydrogen peroxide. This resulted in the generation of holes, which were injected into the silicon wafer 2 via the gold nanoparticles 6. This injection of holes facilitated etching by HF. Hence, the silicon in the vicinity of the gold nanoparticles 6 was etched away, thereby causing a collective sinking of gold nanoparticles 6 into the silicon wafer 2. As the gold nanoparticles 6 formed by the GLAD step 4 did not form a continuous film on the silicon wafer 2, during catalytic etching step 10, those regions of bare silicon remained as freestanding nanowires 8 on the surface of the silicon wafer 2.

The silicon wafer 2 was subsequently subjected to a gold-removal step 12 in which a standard gold etchant was used to remove the gold nanoparticles 6 on the surface of the silicon wafer 2. The silicon wafer 2 was then subjected to an etching solution for a period of time to remove any native oxide before silanization. The silanization step 14 involved placing the silicon wafer 2 in a desiccator (not shown) for a period of time under vacuum (mTorr) with an organosilane solvent to ensure monolayer coverage. Consequently, a silicon wafer 2 having silanized nanowires 16, each nanowire 16 having a distal end 17 and a proximal end 18 adjacent to the substrate 2, on the surface thereon was formed.

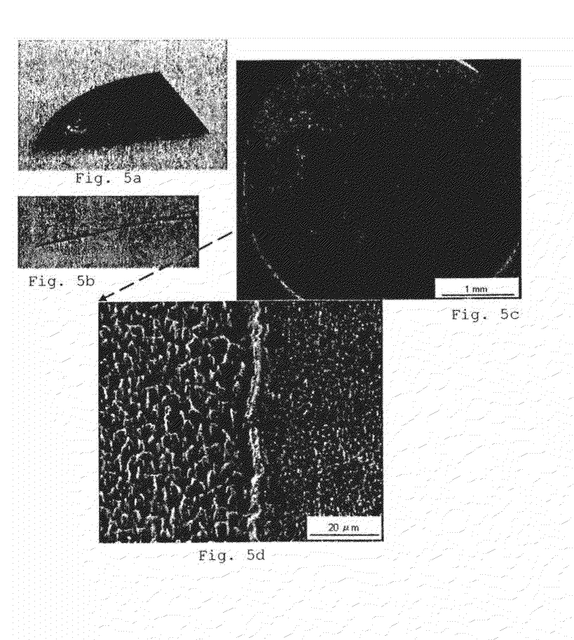

Referring to FIG. 5e, there is shown a process 110 for simultaneously fabricating low-adhesion and high-adhesion superhydrophobic domains on the same silicon surface. Here, like reference numerals as those in FIG. 1 are used here to refer to like features, but are further depicted using a prime (′) symbol.

In process 110, the silicon wafer 2′ was first cleaned as mentioned in FIG. 1. After that, a conventional photolithography step 28 was carried out in which photoresist squares 18 were patterned on the silicon wafer 2′ with the use of a transparency mask (not shown). Next, a GLAD step 4′-1 was first performed to deposit gold nanoparticles 21 with a bimodal size distribution on the silicon wafer 2. A layer of gold nanoparticles 20 was also deposited onto the photoresist squares 18. A lift-off step 30 was then performed to remove the photoresist squares 18 together with the layer of gold nanoparticles 20. A second GLAD step 4′-2 was performed in which the duration of the second GLAD step 4′-2 was controlled such that gold nanoparticles 22 with an unimodal size distribution were deposited on the surface of the silicon wafer 2′ that was previously patterned with the photoresist squares 18. The second GLAD process 4′-2 also cased the gold nanoparticles 21 with the bimodal size distribution to grow further. The silicon wafer 2′ was then subjected to a catalytic etching step 10′ to form the silicon nanowires 8′ on the surface of the silicon wafer 2′. Due to the different durations of the two GLAD steps (4′-1 and 4′-2), the size of the gold nanoparticles (21 and 22) are different, leading to different densities and clumping extent of the nanowires 8′. As can be seen in FIG. 5e, the silicon nanowires 8′ denoted by the region 24 clumped together (or denoted herein as clumped nanowire surface, CNS) while the silicon nanowires 8′ denoted by the regions 26 did not clump together (or denoted herein as non-clumped nanowire surface, NCNS).

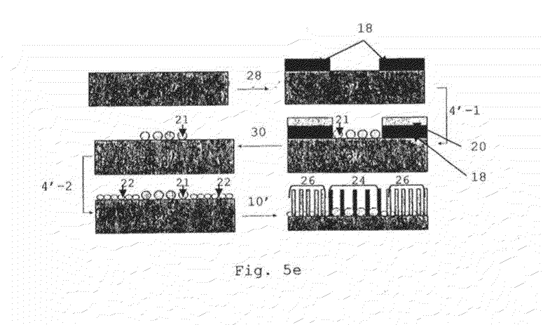

Referring to FIG. 6c, there is shown a process 120 for fabricating a hybrid hydrophilic-superhydrophobic surface. Here, like reference numerals as those in FIG. 1 and FIG. 5e are used here to refer to like features, but are further depicted using a double prime (″) symbol. A layer of SiO₂ 32 was thermally grown on a silicon wafer 2″ by thermal oxidation. A photolithography step 28″ was carried out in order to pattern photoresist squares 18″ on the surface of the silicon wafer 2″. Simultaneously, an etching step 34 was carried out to etch the layer of SiO₂ 32 such that SiO₂ squares were also obtained. This was followed by a GLAD step 4″ to obtain gold nanoparticles 6″ having a bimodal size distribution. A lift-off step 30″ was performed to remove the photoresist squares 18″ from the silicon wafer 2″ by immersing the silicon wafer 2″ in a ketone solvent. The silicon wafer 2″ was subjected to a catalytic etching step 10″. Subsequently, the gold nanoparticles 6″ were removed and the silicon wafer 2″ was silanized as mentioned above.

### EXAMPLES

Non-limiting examples of the invention will be further described in greater detail by reference to specific Examples and a comparative example, which should not be construed as in any way limiting the scope of the invention.

In all of the Examples, methanol and 2-propanol were obtained from Tee Hai Chem Pte Ltd; gold wire was obtained from Scientific Resources Pte Ltd; tridecafluoro-(1,1,2,2-tetrahydrooctyl)trichlorosilane was obtained from Gulf Chemical (S) Pte Ltd; hydrogen peroxide, HF, NH₄OH and HCl were obtained from Megachem Ltd; gold etchant was obtained from Sigma-Aldrich Pte Ltd and silicon wafer was obtained from Trading Resource. All of the above companies are located in Singapore.

### Example 1

The process 100 of FIG. 1 was used here to fabricate a superhydrophobic silicon wafer. A silicon wafer 2 was first cleaned by standard RCA1 (in which the silicon wafer 2 is cleaned in a solution of H₂O, H₂O₂ and NH₄OH) and RCA2 in which the silicon wafer 2 is cleaned in a solution of H₂O, H₂O₂ and HCl) processes. The silicon wafer 2 was subjected to a one minute etch in 10% HF prior to loading into an electron-beam evaporator. The chamber of the electron-beam evaporator was pumped down to a pressure of 10⁻⁶ Torr before commencing a GLAD step 4. GLAD involves the use of an electron source to melt and evaporate the gold wire, which is used as the source for depositing the gold on the silicon wafer 2. During the GLAD step 4, the substrate normal of the silicon wafer 2 was placed at an angle of 87° to the direction of the incoming flux and the silicon wafer 2 was rotated at a rate of 0.2 rpm. Gold nanoparticles 6 were deposited on the surface of the silicon wafer 2 during the GLAD step 4.

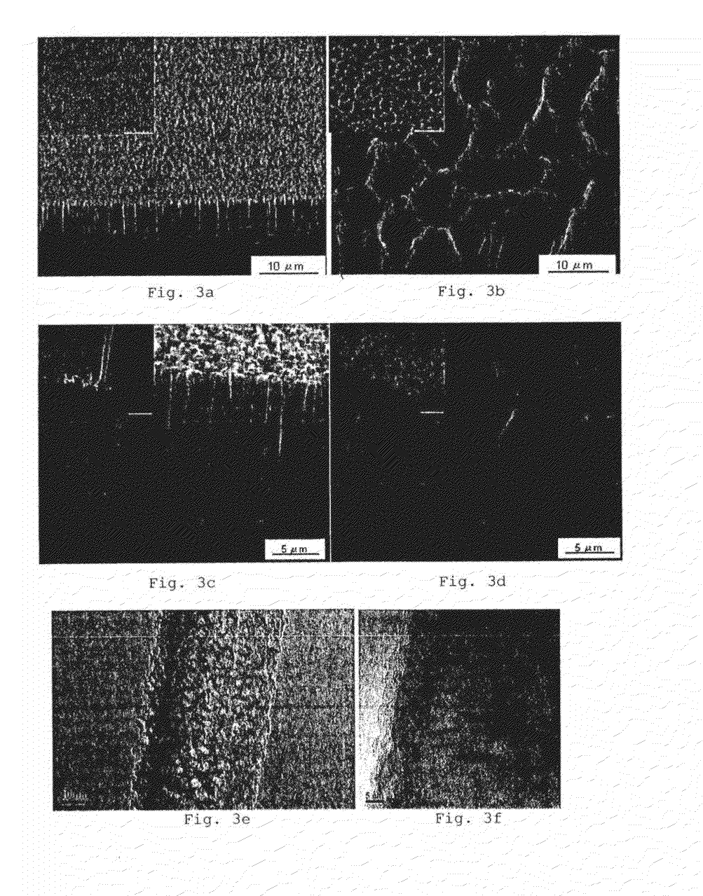

FIG. 2a and FIG. 2b are SEM images of gold nanoparticles on the silicon wafer after the GLAD step.

In FIG. 2a, the duration of the GLAD step was 30 minutes while that used to generate FIG. 2b was 90 minutes. The gold nanoparticles obtained from the GLAD step were found to resemble Apollonian packing. A comparison of FIG. 2a and FIG. 2b showed that larger gold nanoparticles were generated in FIG. 2b, which was generally due to the longer duration of the GLAD step. However, it is to be noted that a longer duration does not imply that all the nanoparticles would be larger. In fact, a closer and tilted SEM image of FIG. 2b, shown in FIG. 2c, revealed many much-smaller-sized nanoparticles embedded between the larger ones. There also seems to be a more uniform distribution of the gold nanoparticle size in FIG. 2a as compared to FIG. 2b. These factors play an important role in the superhydrophobicity of the nanostructured silicon.

FIG. 2d is a histogram of the count versus size of the gold nanoparticles obtained from the 30 minutes GLAD step (as shown in FIG. 2a) and from the 90 minutes GLAD step (as shown in FIG. 2b). It can be observed from FIG. 2d that the gold nanoparticles from the 90 minutes GLAD step exhibited a bimodal particle size distribution, whereas the gold nanoparticles from the 30 minutes GLAD step exhibited a unimodal particle size distribution in which there was a more uniform or smaller spread of Au nanoparticle size. For the bimodal particle size distribution, the particle size of the gold nanoparticles was in the range of about 10 nm to about 100 nm. For the unimodal particle size distribution, the particle size of the gold nanoparticles was in the range of about 10 nm to about 40 nm. This unique difference in the distribution of the particle size of the gold nanoparticles arising from a change in the duration is inherent to the GLAD step. As pointed out above with regard to FIG. 2c, there was a substantial amount of gold nanoparticles embedded between the larger gold nanoparticles, and hence, the number count of the gold nanoparticles from this sample, as indicated in FIG. 2d, should be treated as an underestimate.

The explanation between the different particle sizes and particle size distribution of the gold nanoparticles as a result of the duration of the GLAD step is as follows: During the initial stages of the GLAD step, nuclei 40 condensed on the silicon surface and coalesced to form individual islands (nuclei with captured adatoms, 42) that geometrically shadowed the silicon due to the oblique arrival angle (of 87°) and the low diffusivity of the adatoms. As a result, atomic shadowing (illustrated in FIG. 2e) took place and prevented the formation of a continuous thin film. The arrows in FIG. 2e illustrated the arrival of atomic flux. As the deposition process continued, the nuclei with captured adatoms 42 captured more nuclei 40 and grew in the direction of the vapor source. By rotating the silicon wafer, the net direction of nuclei growth could be resolved vertically. Due to the competitive nature of the atomic shadowing process, as soon as a nucleus outgrew its neighboring nuclei, it essentially stopped all further growth of those nuclei in its vicinity. Therefore, in a shorter GLAD step, most of the nuclei would have grown at a similar rate and result in gold nanoparticles of similar sizes, with a unimodal distribution, as shown in FIG. 2a. As the GLAD step continued for a longer period of time, more and more nuclei were restricted from growing further due to atomic shadowing caused by the larger nuclei. These larger nuclei captured more adatoms and further increased in size, resulting in a large size distribution, that is, the bimodal distribution of gold nanoparticles as shown in FIG. 2b and FIG. 2c.

Referring back to FIG. 1, after the gold nanoparticles 6 were deposited onto the surface of the silicon wafer 2, the silicon wafer 2 was then subjected to a metal-assisted catalytic etching step 10 by using an etching solution of H₂O, HF and H₂O₂ at room temperature with the concentrations of HF and H₂O₂ fixed at 4.6 and 0.44 M, respectively. The etching time used was 20 minutes. During this step, the gold nanoparticles 6 acted as catalysts that facilitated the reduction of hydrogen peroxide. This resulted in the generation of holes, which were injected into the silicon wafer 2 via the gold nanoparticles 6. This injection of holes facilitated etching by HF. Hence, the silicon in the vicinity of the gold nanoparticles 6 was etched away, thereby causing a collective sinking of gold nanoparticles 6 into the silicon wafer 2. As the gold nanoparticles 6 formed by the GLAD step 4 did not form a continuous film on the silicon wafer 2, during catalytic etching step 10, those regions of bare silicon remained as freestanding nanowires 8 on the surface of the silicon wafer 2.

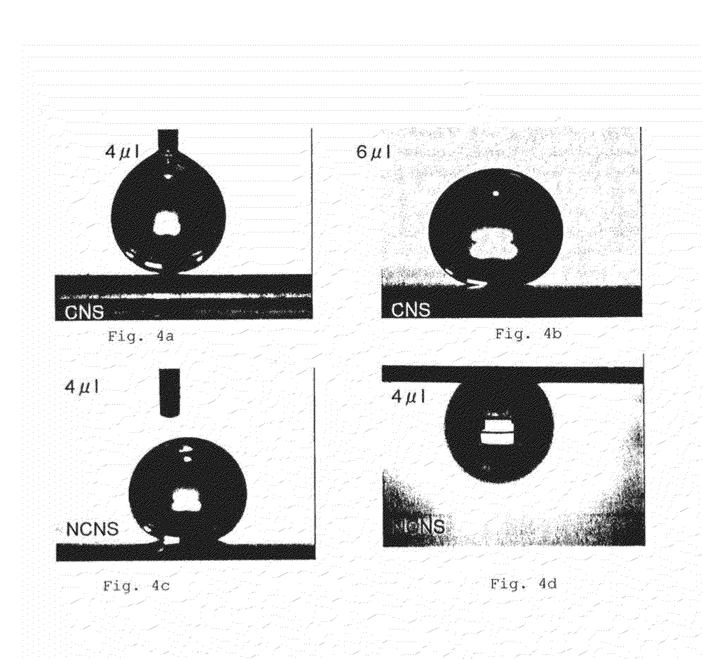

FIG. 3a and FIG. 3b are SEM images of the silicon nanowires after metal-assisted catalytic etching of the two types of samples that correspond to FIG. 2a and FIG. 2b respectively. FIG. 3a showed straight silicon nanowires that were obtained from the sample with the 30 minutes GLAD duration while FIG. 3b showed bent silicon nanowires with pronounced clumps that were obtained from the sample with the 90 minutes GLAD duration. Both samples in FIG. 3a and FIG. 3b were catalytically etched for 20 minutes, resulting in silicon nanowires having a length of about 15 μm. Although both types of nanowires in FIG. 3a and FIG. 3b have similar heights and diameters, for a similar etching duration, their morphology is clearly different. The distal ends of the silicon nanowires in FIG. 3b showed a much more significant clumping than the straighter nanowires in FIG. 3a, which was attributed to elastocapillary coalescence. Hereafter, these surfaces will be referred to as the CNS and NCNS, respectively.

FIG. 3c and FIG. 3d are cross-sectional SEM images of nanowires similar to those in FIG. 3a and FIG. 3b illustrating the freestanding silicon nanowires with gold nanoparticles that have “sunk” as the silicon is etched down. The insets in these figures are close up SEM images of the gold nanoparticles.

TEM analysis revealed that silicon nanowires with a typical thickness ranging from ˜10 to ˜100 nm were obtained from samples catalytically etched with gold nanoparticles obtained from carrying out the GLAD step for 30 minutes (FIG. 3e) and for 90 minutes (FIG. 3f). From FIG. 3e and FIG. 3f, it can be observed that the nanowire in FIG. 3f is more porous than the nanowire in FIG. 3e. The TEM image in FIG. 3e shows a silicon core surrounded by a porous silicon surface and the TEM in FIG. 3f shows a completely mesoporous silicon nanowire. The difference in the porosity is believed to have given rise to nanowires of different rigidity, such that wires from the CNS sample were less rigid than those in the NCNS sample. The lower rigidity of the nanowires in FIG. 3f aids the elastocapillary coalescence and resulted in the formation of clumps of nanowires in the CNS sample that resembled nanoscale “haystacks”.

Referring back to FIG. 1, the silicon wafer 2 was subsequently subjected to a gold-removal step 12 in which a standard gold etchant composed of iodine and potassium iodide was used to remove the gold nanoparticles 6 on the surface of the silicon wafer 2. The silicon wafer 2 was then subjected to 10% HF etch for one minute to remove any native oxide before silanization. The silanization step 14 involved placing the silicon wafer 2 in a desiccator (not shown) for 12 hours under house vacuum of 1 to 10 mTorr with 6 μl of tridecafluoro-(1,1,2,2 tetrahydrooctyl)trichlorosilane to ensure monolayer coverage. Consequently, a silicon wafer 2 having silanized nanowires 16 on the surface thereon was formed. The contact angle of the bare silicon increased from ˜76.6° to ˜119.1° after the silanization process.

The contact angle of the two types of samples was measured. For all contact angle measurements, unless otherwise stated, deionized water droplets of 4 μl were used for all contact angle measurements. All measurements reported were obtained from an average of 5 measurements.

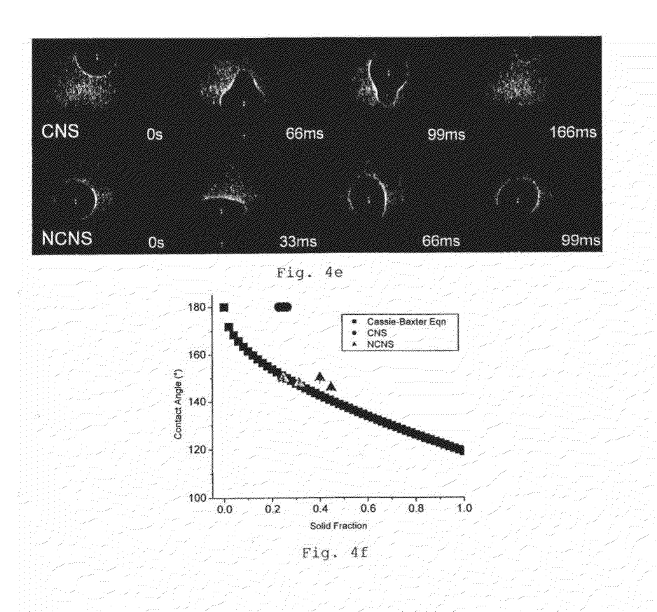

FIG. 4a and FIG. 4b showed the contact angle (CA) measurements of deionized water on silanized CNS. FIG. 4a and FIG. 4b showed a 4 μl and 6 μl drop of water on the CNS respectively. The CNS proved to be very effective at repelling water, as evident from the need for at least a 6 μl drop of water to make CA measurements. Drops of smaller volumes would remain on the syringe instead. FIG. 4a and FIG. 4b demonstrated that a superhydrophobic silicon surface could be obtained from CNS. The CNS exhibited a contact angle of 156°±0.5° with negligible hysteresis and was observed to mimic the low-adhesion superhydrophobic (“roll-off”) nature of a lotus leaf.

FIG. 4c showed the CA measurement of deionized water on silanized NCNS, in which the CA is about 150°±2°. It is to be noted that the silicon surface showed a high hysteresis of ˜27°. CA hysteresis was measured by taking the difference between advancing CA and receding CA. Advancing CA is defined as the CA just before the contact line advances as water is dispensed on the surface. Similarly, the receding CA is defined as the CA just before the contact line recedes as water is withdrawn from the surface. In addition, the surface exhibited an ability to pin a droplet of water, even with a tilting of the surface upside down (i.e., at a tilting angle of 180°), as depicted in FIG. 4d. Hence, the NCNS mimicked the high-adhesion nature of a rose petal. It was observed that the NCNS was able to hold liquid droplets of up to 6.5 μl, which is better than other high-adhesion superhydrophobic surfaces of the prior art.

FIG. 4e is a series of snapshots illustrating the different wetting behavior of the NCNS and CNS by dispensing a drop of water of diameter of around 1 mm from a height of around 3 cm. The snapshots shown in FIG. 4e clearly illustrated the differences in wetting behaviors: the drop bounces off the CNS (the lotus-like surface) while the drop gets pinned, vibrated and eventually came to rest on the NCNS (the petal-like surface).

FIG. 4f is a graph comparing the CA measurements obtained from the CNS and NCNS with the Cassie-Baxter equation. This graph highlights that the contact angle measured on the CNS and NCNS fit in the theoretical Cassie-Baxter model.

It is to be noted that this is the first demonstration of using the same fabrication process to tune the adhesion of a superhydrophobic surface from high to low adhesion.

### Example 2

This example demonstrates the fabrication of a single substrate with both low- and high-adhesion superhydrophobic regions. Hence, this example provides, for the first time, the possibility of tuning the adhesion of a superhydrophobic surface to simultaneously obtain both low- and high-adhesion superhydrophobic surface on a single substrate, as compared to prior art methods in which low- and high-adhesion superhydrophobic surfaces could only be fabricated on separate substrates.

Referring to FIG. 5e, there is shown a process 110 for fabricating low-adhesion and high-adhesion superhydrophobic domains on the same silicon surface.

In process 110, the silicon wafer 2′ was first cleaned as mentioned in FIG. 1. After that, a conventional photolithography step 28 was carried out in which photoresist squares 18 of 2 mm in dimension were patterned on the silicon wafer 2′ with the use of a transparency mask (not shown). Next, a GLAD step 4′-1 was first performed to deposit gold nanoparticles 21 with a bimodal size distribution on the silicon wafer 2. A layer of gold nanoparticles 20 was also deposited onto the photoresist squares 18. A lift-off step 30 was then performed to remove the photoresist squares 18 together with the layer of gold nanoparticles 20. A second GLAD step 4′-2 was performed in which the duration of the second GLAD step 4′-2 was controlled such that gold nanoparticles 22 with an unimodal size distribution were deposited on the surface of the silicon wafer 2′ that was previously patterned with the photoresist squares 18. The second GLAD process 4′-2 also cased the gold nanoparticles 21 with the bimodal size distribution to grow further. The silicon wafer 2′ was then subjected to a catalytic etching step 10′ to form the silicon nanowires 8′ on the surface of the silicon wafer 2′. Due to the different durations of the two GLAD steps (4′-1,4′-2), the size of the gold nanoparticles (21,22) are different, leading to different densities and clumping extent of the nanowires 8′. As can be seen in FIG. 5e, the silicon nanowires 8′ denoted by the region 24 clumped together (or denoted herein as CNS) while the silicon nanowires 8′ denoted by the regions 26 did not clump together (or denoted herein as NCNS).

FIG. 5a is a photograph of a silicon sample in which the surface had been fabricated with both CNS and NCNS on the same silicon surface. The NCNS region is denoted by the squares of 2 mm in length while the CNS surrounds the NCNS. A 4 μl drop of deionized water is also shown resting on the NCNS region. FIG. 5b showed a tilted view of the droplet sticking to the surface. FIG. 5c is a SEM image of the 2 mm by 2 mm square. FIG. 5d is a SEM image showing the boundary between the CNS and NCNS that clearly showed the different morphology of the CNS and NCNS. It is to be noted that the water droplet is unable to adhere to the regions outside the square (CNS) and the ease in pinning the water droplet even when it is tilted to 180° in regions within the square (NCNS). FIG. 5d further verified that the CNS and NCNS could be simultaneously obtained by simply patterning and etching the silicon with gold nanoparticles with different size distributions. The fabrication process 110 also showed the compatibility of the GLAD-catalytic etching (GLAD-CE) step with conventional, simple microelectronic fabrication steps.

### Example 3

This example demonstrates the fabrication of a single substrate with different wetting properties (hydrophilic-superhydrophobic) using the GLAD-CE technique.

Referring to FIG. 6c, there is shown a process 120 for fabricating the above substrate with different wetting properties (hydrophilic-superhydrophobic).

A layer of SiO₂ 32 was thermally grown on a silicon wafer 2″ by thermal oxidation. A photolithography step 28″ was carried out in order to pattern photoresist squares 18″ of 0.5 mm dimension on the surface of the silicon wafer 2″. Simultaneously, a HF etching step 34 using 10% HF solution was carried out to etch the layer of SiO₂ 32 such that SiO₂ squares of 0.5 mm dimension were also obtained. This was followed by a GLAD step 4″ to obtain gold nanoparticles 6″ having a bimodal size distribution. A lift-off step 30″ was performed to remove the photoresist squares 18″ from the silicon wafer 2″. The silicon wafer 2″ was subjected to a catalytic etching step 10″ for 20 minutes. Subsequently, the gold nanoparticles 6″ were removed and the silicon wafer 2″ was silanized as mentioned above.

FIG. 6a is a SEM image at low magnification of a silicon surface having two different wetting properties. Here, a hydrophilic SiO₂ square of 0.3 mm length surrounded by CNS is shown. FIG. 6b is a SEM image showing the different surface roughness between the CNS and the SiO₂ surface.

The ability to integrate the hydrophilic region surrounded by the superhydrophobic region artificially mimics the wetting characteristics of the wings of the Stenocara beetle in the Namib Dessert, on a silicon substrate. To illustrate the wetting properties of such a surface, the silicon wafer was simply immersed in deionized water and taken out. FIG. 6d is a photograph illustrating that small drops of water wet the hydrophilic surface only while the CNS region remained dry.

### Example 4

This example demonstrates the fabrication of three types of superhydrophobic silicon substrates which were dried in different types of solvents before the silanization step.

The process 100 of FIG. 1 was used here to fabricate a superhydrophobic silicon wafer and is similar to that mentioned in Example 1 but with an additional solvent soaking step. This additional solvent soaking step occurred after the etching step 10 in which the three samples were immediately taken out of the etching solution and rinsed in deionized water. Care was taken to ensure that the samples did not dry up while transporting between liquids. After rinsing, the samples were placed in a beaker containing deionized water, 2-propanol or methanol, sufficient to fully immerse the samples and were left to dry in air under ambient conditions. Following this, the process 100 of FIG. 1 was continued with the samples being subjected to a gold-removal step 12 and silanization step 14.

The nanowires were examined by transmission electron microscopy which showed that the nanowires varied in thickness between about 10 nm to about 100 nm. Using SEM to examine the nanowires determined that the height of the nanowires was about 20 μm. The nanowires were also observed to be mesoporous with the inter-nanowire spacing as between about 100 nm to about 1 μm.

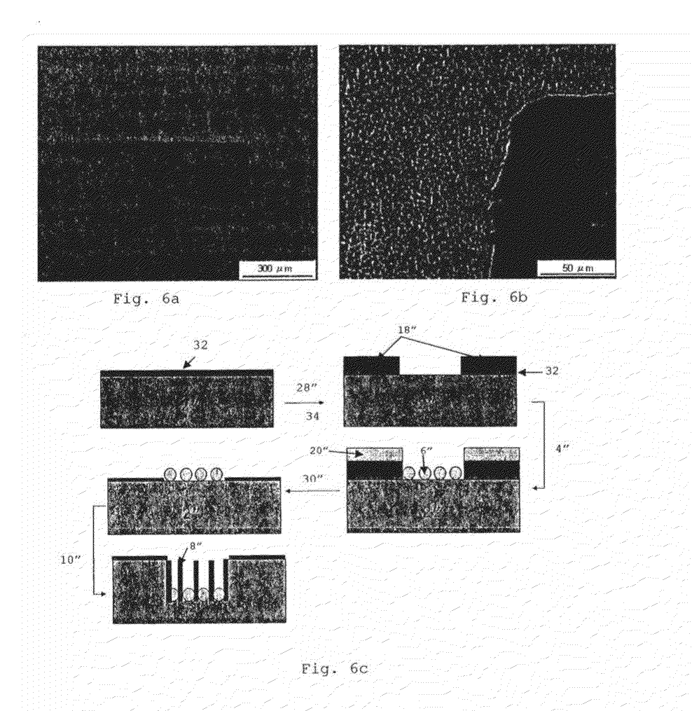

FIG. 7a, FIG. 7b and FIG. 7c are top-view SEM images showing the silicon nanowire morphologies after drying in the water, 2-propanol and methanol, respectively. It is to be noted that the different drying media caused significantly different nanowire cluster morphologies. In fact, interconnected cluster networks were formed. Because of the fine thickness of the nanowires, random distributions of the thicknesses and random distances between the nanowires, it was difficult to quantify the actual number of nanowires per cluster. The water-dried GLAD-CE sample 9 as shown in FIG. 7a) consisted of nanowires with small clusters (˜1 μm sized clusters at tips) while the 2-propanol- (as shown in FIG. 7b) and methanol-dried (as shown in FIG. 7c) samples consisted of larger clusters of nanowires (˜3 and ˜5 μm sized clusters at tips, respectively). The methanol-dried samples (FIG. 2c) resulted in the largest degree of nanowire clustering; i.e. largest cluster size.

FIG. 8 is a histogram of solid fraction f, representing the fraction of the surface comprised by the solid, which was estimated from digitally analyzed SEM images of FIG. 7a, FIG. 7b, and FIG. 7c. The increase in average size of the cluster represented a higher solid fraction and therefore a higher solid-surface-to-air ratio. The smaller nanowire clusters of the water-dried sample (FIG. 7a) led to the smallest solid fraction of 0.17, the 2-propanol-dried sample (FIG. 7b) resulted in a solid fraction of 0.21 while the methanol-dried sample (FIG. 7c), consisting of the largest nanowire clusters, resulted in the largest solid fraction of 0.29.

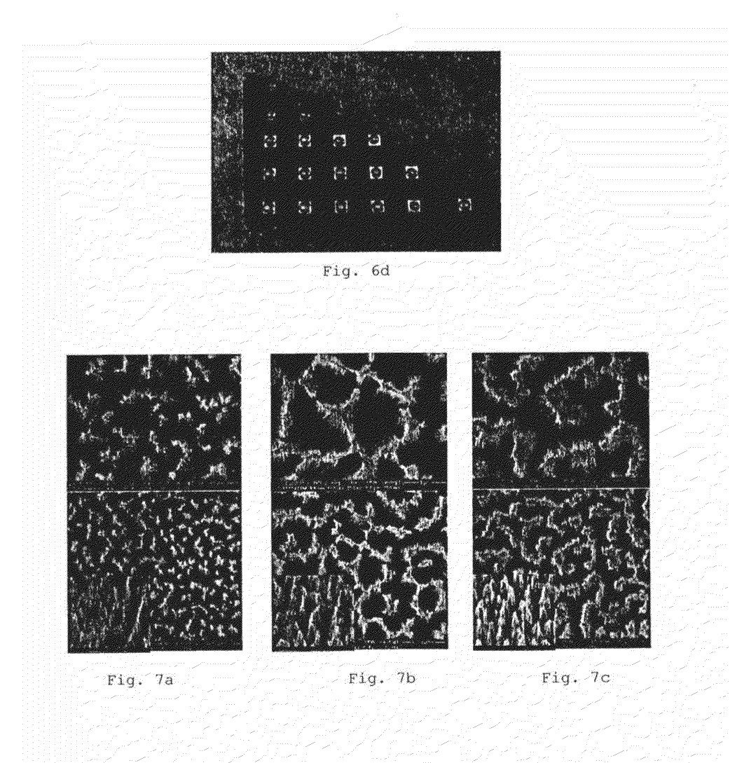

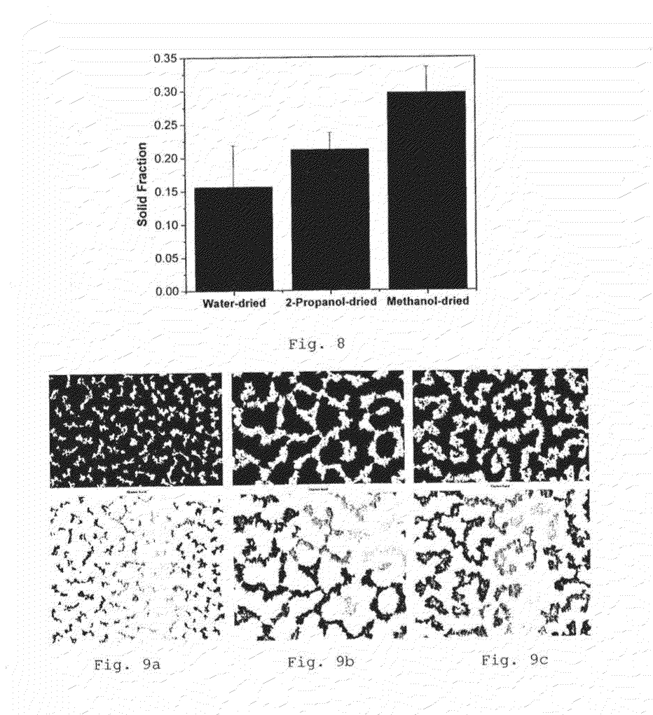

In addition, the percolation (that is, the connectedness of the clusters) of the nanowire clusters was determined. FIG. 9a, FIG. 9b and FIG. 9c show the percolation results from digitally analyzed SEM images of FIG. 7a, FIG. 7b and FIG. 7c respectively. To determine the percolation of the clusters obtained, SEM images of FIG. 7a, FIG. 7b and FIG. 7c were first digitized into black and white pixels as shown by the top row images of FIG. 9a, FIG. 9b and FIG. 9c to only identify the tips of the nanowire clusters. The colored images (as seen in the bottom row) of FIG. 9a, FIG. 9b and FIG. 9c denoted the percolation in the images. FIG. 9a shows that the small clusters in the water-dried sample do not form a percolation path. Although the largest nanowire cluster size was obtained in methanol-dried sample, its percolation length (see FIG. 9c) is not as long as that in 2-propanol. This meant that the nanowire clusters were more connected to each other when dried in 2-propanol as compared to the nanowire clusters when dried in methanol. The differences between solid fractions and percolation lengths will significantly affect the wettability between the surfaces.

The above observations can be explained by equation (2) mentioned above. In the above experiments on drying with different liquids, all other parameters were kept constant except the surface tension and the Young's angle. One would expect that, with the change of the liquid medium from deionized water to methanol, the resulting reduction in surface tension should cause a smaller capillary force and that therefore the nanowires would cluster less in methanol than in water. However, the effect of Young's angle, θ₀, in the above equation needed to be taken into account. Table 1 summarizes reported values of surface tension (γ₁ₐ) and measured values of CA (θ₀) in the above experiment. By varying only the solution used in the drying process, the term γ₁ₐ cos² θ₀ in equations (1) (as mentioned above) and (2) can be varied. It is to be noted that the low surface tension of methanol and 2-propanol on silicon resulted in a very small Young's angle (θ₀˜0°); that is, the liquid tended to wet the surface completely. This makes cos² θ₀˜1. As Table 1 indicates, the γ₁ₐ cos² θ₀ for methanol is the largest while the γ₁ₐ cos² θ₀ is smallest for deionized water. This accounted for the smallest cluster size of nanowires dried in water compared to what was obtained with drying in 2-propanol, with the largest cluster size obtained by drying in methanol.

TABLE 1

| | γₗₐ (mN/m) | | | |
|---|---|---|---|---|
| | at 25° C. | θ₀ (°) | cos² θ₀ | γₗₐ cos² θ₀ |
| Water | 73 | 77 | 0.05 | 4 |
| 2-propanol | 21 | ~0 | 1 | 21 |
| methanol | 22 | ~0 | 1 | 22 |

The bending of the nanowires was determined by the elastic force required, as shown in Equation (3) above. As mentioned above, the nanowires were mesoporous in nature. Hence, as the porosity of silicon increased, its Young Modulus, E, decreased. During the drying process, the thin nanowires experienced the largest deflection when the liquid meniscus was at the tips of the nanowires. Here, the large capillary force caused a sufficiently large deflection to cause neighboring nanowires to touch each other and thereby remain stuck due to strong van der Walls forces. When the liquid medium was changed from methanol to water, the applied capillary force decreased, resulting in smaller deflection which was capable of bending only the nearby nanowires together and hence leading to the formation of smaller sized clusters. It is to be noted that the shorter the nanowires are, the lesser is the clustering effect (data not shown). In addition, the stiffer the nanowires are, the lesser is the clustering effect (data not shown).

FIG. 10a, FIG. 10b and FIG. 10c shows images of CA measurements of 6 μl of deionized water on silanized nanostructured silicon surfaces of FIG. 7a, FIG. 7b and FIG. 7c respectively. Table 2 summarizes the CA and hysteresis measurements of the surfaces. The silanized water-dried GLAD-CE sample exhibited the highest CA of 152.6°±0.2° with negligible hysteresis of 2°. Hence, a lotus-like superhydrophobic surface was achieved via drying in water. The 2-propanol dried sample exhibited a CA of 146.9°±0.1° with a hysteresis of 22° while the methanol-dried sample exhibited the smallest CA of 143.0°±0.1° with a hysteresis of 13°. As can be observed, the degree of nanowire cohesion modulates the wettability of the surface.

TABLE 2

| | | CA |
|---|---|---|
| | | hysteresis |
| | CA (°) | (°) |
| Water-dried | 152.6 ± 0.2 | 2 |
| 2-propanol-dried | 136.9 ± 0.1 | 22 |
| Methanol-dried | 143 ± 0.1 | 13 |

As mentioned earlier, the different sizes of the nanowire clusters caused by variations in nanocohesion resulted in different solid fraction. The increase in average size of nanowire cluster increased the solid fraction of the surface and therefore resulted in a higher solid surface area to water when a droplet sat on the surface. The high contact angles obtained from the three types of substrates can be explained by the Cassie-Baxter equation (4) above.

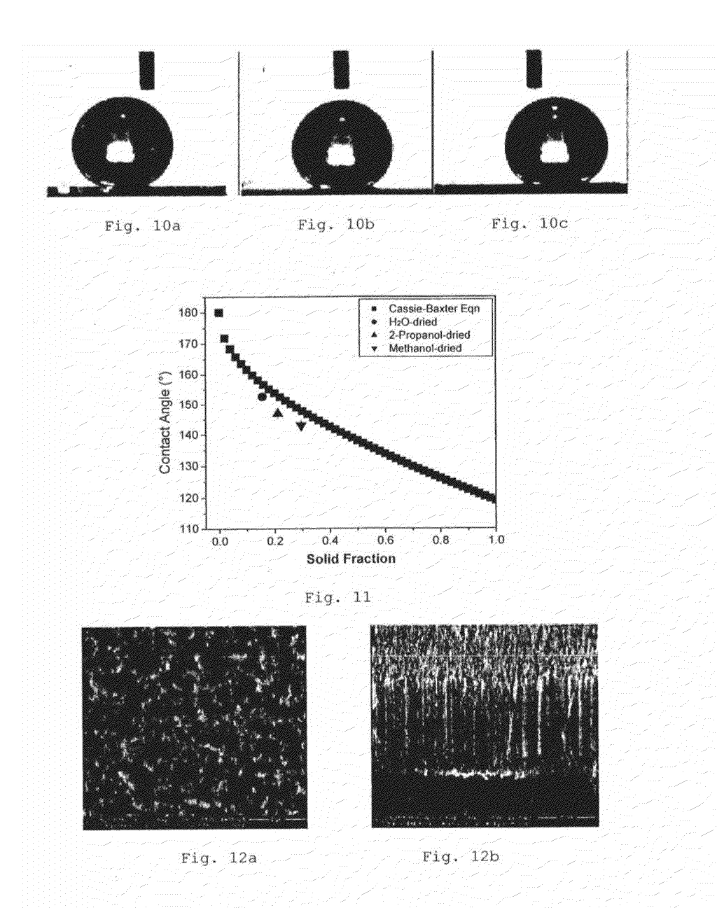

FIG. 11 shows that CA measurements on the respective clustered nanowire surfaces followed the prediction of the Cassie-Baxter equation quite closely. The water-dried nanowire surface made up of small clusters of nanowires resulted in the smallest solid fraction and hence, the largest CA measurements, as expected by the Cassie-Baxter model. Similarly, the methanol-dried sample consisted of the largest clusters of nanowires, presented the highest solid fraction seen by the water droplet and therefore the smallest CA.

The CA hysteresis can be explained in terms of contact line pinning. The contact line represents the region where the three phases, solid, liquid, and air meet. The contact line pinning occurs at the perimeter of the pillars as water recedes over the posts. Hence, the greatest energy to move a contact line from one post to another as the droplet recedes occurs at the perimeter of the post. A larger perimeter results in greater pinning and macroscopically results in a larger hysteresis. If each nanowire cluster is assumed as a single post, the circumference of the tips of the nanowire clusters gives the perimeter of this “post”. The larger cluster size and percolation lengths in methanol-dried and 2-propanol-dried samples had a larger perimeter and therefore exhibited a larger pinning force on the water meniscus, which resulted in a larger CA hysteresis. The longer percolation length obtained from 2-propanol-dried sample represented a long contact line and therefore a large pinning capability that explained the highest hysteresis obtained with this sample. The small cluster of nanowires in water-dried sample resulted in a small perimeter per cluster and had a smaller pinning capability and translated to the negligible CA hysteresis observed.

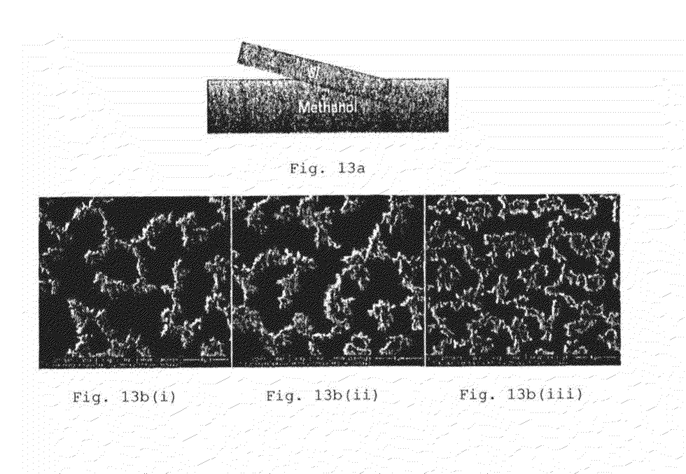

The nanowires were subjected to critical point drying (CPD) in order to eliminate any surface tension and capillary effects during the drying process as a comparison to the capillary-clustered nanowires. CPD refers to a process of removing liquid and is performed in a critical point dryer and dried under liquid CO₂. The system is brought into the supercritical region (high temperature and high pressure state) where there is no longer a distinction between liquid and gas phases, while keeping the density of liquid and vapor equal. In doing so, the effects of surface tension during drying are eliminated. FIG. 12a and FIG. 12b shows the top-view and cross-sectional SEM images of GLAD-CE nanowires after CPD respectively. The nanowires appeared straighter and significantly less clustered. It also shows the randomness of the spacing between nanowires and their thickness. CA measurements revealed a CA of 143.5°±0.2° and a hysteresis of 10.3° on the silanized nanowires. It was also noted that CA increased after several CA measurements. SEM images revealed that after CA measurements, the nanowires became more clustered; suggesting that nanocohesion took place during the CA measurement of the CPD sample.

### Example 5

This example demonstrates the fabrication of a single substrate with nanowires of different degrees of nanocohesion by controlling the drying process and medium. This results in the ability to control and modulate the adhesion on a superhydrophobic substrate.

FIG. 13a schematically describes and shows GLAD-CE nanowires being partially dried in water and methanol. The process of Example 4 was used here. However, instead of immersing the sample into a single solvent, the sample was first rinsed in copious amounts of deionized water. The sample was then withdrawn from the deionized water bath and partially immersed in methanol while still being wet. Half the sample was wet with water and exposed to air, while the other half was immersed in methanol. The sample was left until the methanol had evaporated.

A sharp transition was not observed between the water-dried and methanol-dried regions. Instead, the average cluster size generally increased in moving from the water-dried to the methanol-dried region. FIG. 13b is a series of SEM images showing the difference in cluster size when moving from b(i) water-dried region, b(ii) the boundary between the water-dried and methanol-dried regions, and b(iii) methanol-dried region.

Next, the sample was silanized as mentioned previously. The different wetting behavior of the substrate was then investigated. A 4 μl droplet was dispensed on the water-dried region of the sample, which was inclined at an angle of 10°. Due to the low-hysteresis, superhydrophobicity of the water-dried region, the water droplet rolled down the surface and was pinned on the high-hysteresis, methanol-dried region (data not shown).

### Example 6

This example demonstrates the fabrication of a single substrate with different stripes of large-clustered, methanol-dried, silicon nanowires between regions of water-dried nanowires.

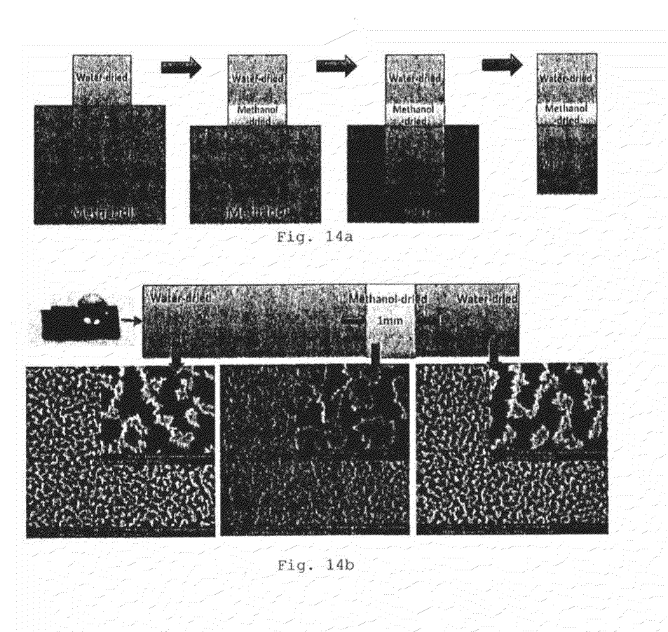

FIG. 14a schematically illustrates the drying process employed and is described below. The rest of the process is the same as that described in Example 4 above.

In FIG. 14a, a piece of GLAD-CE nanowire surface was rinsed in deionized water immediately after metal-assisted chemical etching. The wet sample was then placed in a beaker partially filled with methanol. The exposed region of the sample (wet with water) began to dry. The sample was left partially submerged in methanol and was left to evaporate for 2 hours upon which a width of 4 mm region of methanol-dried nanowires was obtained. The methanol was then drained from the container and filled with deionized water till the end of marking from the methanol-dried region. The sample was left to completely dry till all the water evaporated to obtain the water-dried region of nanowires again.

FIG. 14b shows the different nanowire morphologies along the length of the sample showing the distinct clustering of nanowires due to different drying processes. A gradual transition of clustering was observed near both boundaries between methanol-dried and water-dried regions. After the drying step, the sample underwent the same silanization process as mentioned previously.

The different wetting behavior of the striped superhydrophobic surface was then investigated. A 4 μl water droplet (˜1 mm diameter) was dispensed on the water dried-region of the sample. The water droplet rolled down the low-hysteresis superhydrophobic region and came to a stop and remained pinned upon reaching the methanol-dried stripe. The stripe of methanol-dried silicon nanowires was capable of stopping the incoming droplet, much like an anchor of a ship. In another test, a 16 μl water droplet (˜4 mm diameter) was similarly dispensed on the water-dried region. Again, the water droplet rolled down the surface. However, due to the large volume of liquid, the stripe of methanol-dried silicon nanowires failed to stop the incoming drop. Momentum carried the huge droplet further down the stripe to the superhydrophobic region and rolled off the sample. The short distance of the stripe was unable to slow and stop the incoming droplet. This example illustrated the potential application of using the different wetting behaviors of the clustered nanowire surfaces as “rails” and “anchors” to guide the flow of droplets for potential microfluidic applications.

### Example 7

This example demonstrates the relationship between GLAD duration and metal-assisted chemical etching duration and their effects on surface wettability.

The process of FIG. 1 was followed here, except that the duration of the GLAD step and CE step were varied.

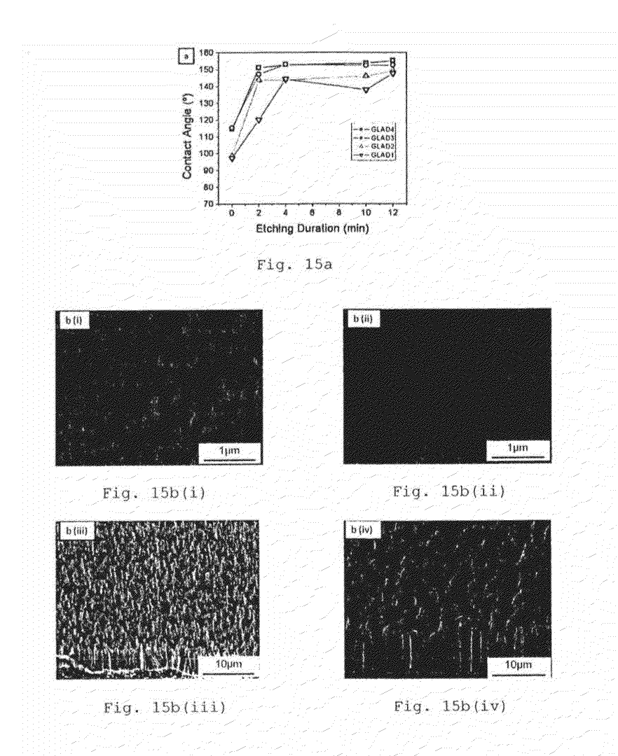

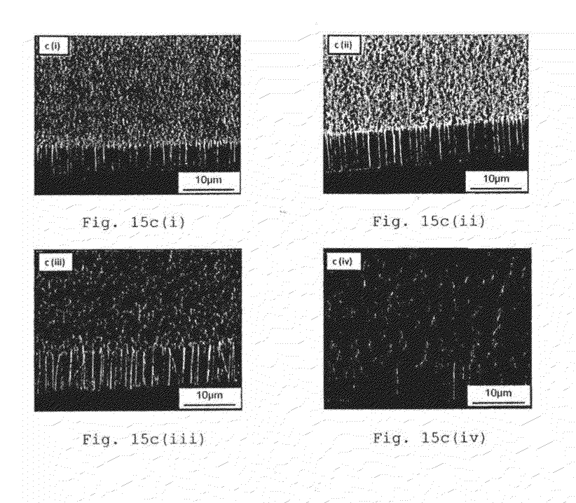

FIG. 15a is a graph of the CA measurements with varying metal-assisted CE durations at different GLAD durations. GLAD1 corresponded to a GLAD duration of 17 minutes; GLAD2 corresponded to a GLAD duration of 33 minutes; GLAD3 corresponded to a GLAD duration of 67 minutes; and GLAD4 corresponded to a GLAD duration of 100 minutes. It was observed that the CA increased and saturated with increasing etching duration. The increase in CA with increasing etching duration is a consequence of longer nanowires, which resulted in the increased clumping of nanowires as shown in FIGS. 15b(i) to 15b(iv). The clumping of nanowires helped in further reducing the solid fraction f required to achieve superhydrophobicity. FIG. 15c(i) to FIG. 15c(iv) are SEM images showing silicon nanowires arrays with varying morphologies obtained by the metal-assisted CE of silicon for 20 minutes with increasing GLAD duration: c(i) 17 minutes GLAD; c(ii) 33 minutes GLAD; c(iii) 67 minutes GLAD; and c(iv) 100 minutes GLAD. As can be observed from these figures, the clumping of the nanowires become more severe and the height of the nanowires increased as the GLAD duration increased. Increased nanowire height was attributed to the presence of more gold nanoparticles to facilitate the etching of silicon with increased GLAD duration. Increased nanowire clumping decreased the solid fraction and also increased the air pockets on the surface, thereby making the surface more superhydrophobic. It was also observed that the sticking and roll-off characteristics do not show a sharp transition at intermediate GLAD durations (of 33 minutes and 67 minutes GLAD durations.

### Comparative Example

In order to determine if depositing a film of gold on the silicon substrate would have the same effect as depositing gold nanoparticles on the silicon substrate, a comparative example was carried out in which a film of gold of varying thickness was deposited on the silicon substrate by conventional thermal evaporation.

Here, two samples were fabricated in which 3 nm and 12 nm of gold was deposited on silicon by conventional thermal evaporation. The samples were then subjected to the same catalytic etching and silanization process mentioned earlier.

It was observed that the 3 nm thick gold film on the silicon was able to yield wetting properties similar to those of the NCNS (CA of up to ˜150° with high hysteresis). This was due to the straighter nanowires obtained from etching silicon with such a discontinuous thin Au film. When the thickness of the gold film was increased to 12 nm, the gold film collectively sunk into the silicon, forming a minimally roughened surface, which resulted in a decrease in CA (up to 130-140°). Thicker gold films similarly resulted in lower CA due to the reduced roughness. This illustrates that a surface produced with a simple catalytic etching of Si with conventionally evaporated Au on silicon was not able to transit between a petal-like state to a lotus-like state, thus reinforcing the uniqueness of our GLAD-CE process, which creates the CNS and NCNS made possible by the bimodal and unimodal size distribution of Au nanoparticles.

The disclosed process of altering the wetting property of a substrate surface disclosed herein may be used to fabricate tunable hydrophobic surfaces for microfluidic lab-on-chip devices. The disclosed process may also be used to fabricate functional biomimetic surfaces such as the fabrication of micrometer-scale polymeric surfaces mimicking the adhesive properties of a gecko's feet. The disclosed process may also be used to fabricate platforms to develop sensitive methods for biological and chemical detection where minimal liquid-substrate interaction is desired. For example, a particular droplet of liquid in a defined location on a surface could be analyzed or a platform could be developed to study in-situ chemical mixing and interfacial reactions of liquid pearls.

Advantageously, both high and low-adhesion superhydrophobic surfaces may be produced on a single substrate by controlling the clustered and non-clustered areas of nanostructures on a substrate.

Advantageously, the fabrication of either CNS or NCNS may be controlled by the duration of the GLAD step.

Advantageously, the use of different liquid media allows the degree of aggregation of the nanostructures to be tuned in order to obtain different morphologies and hence either CNS or NCNS can be obtained on a substrate.

More advantageously, the disclosed method may allow the fabrication of hybrid surfaces with tunable adhesion (high and low adhesion superhydrophobic surfaces) and with hybrid wetting properties (i.e. both hydrophilic and superhydrophobic).

Advantageously, the disclosed method is entirely scalable over large areas (up to entire 4″ wafers or more) and does not require complex lithography (such as electron-beam lithography) and etching processes (such as deep-RIE), which are synonymous with conventional top-down nanofabrication.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1.-32. (canceled)

33. A process for altering the wetting property of the surface of a substrate, the method comprising the steps of:
(a) providing an array of nanostructures on the substrate, each nanostructure having a proximal end adjacent to the substrate and a distal end opposite to said proximal end; and
(b) moving the distal ends of at least one subset of said array of nanostructures towards each other to thereby form at least one nanostructure cluster, wherein the nanostructures of each cluster have distal ends that are spaced closer to each other relative to the respective proximal ends of said adjacent nanostructures, said nanostructure cluster altering the wetting property of the substrate.

34. The process as claimed in claim 33, wherein the moving step comprises the steps of:
(a) providing the nanostructures in a liquid medium, wherein the distal ends of adjacent nanostructures are about the same distance as that of the adjacent proximal ends; and
(b) removing the liquid medium from the nanostructures to move the distal ends of adjacent nanostructures towards each other and thereby form the at least one cluster thereon.

35. The process as claimed in claim 34, wherein the removing step comprises the step of adjusting the rate of removal of the liquid medium to alter the dimensions of the formed cluster.

36. The process as claimed in claim 34, wherein the liquid medium is water.

37. The process as claimed in claim 34, wherein the liquid medium has a higher volatility relative to water.

38. The process as claimed in claim 34, wherein the rate of removal of the liquid medium is adjusted by the pressure under which the liquid medium is removed from the substrate.

39. The process as claimed in claim 34, wherein the rate of removal of the liquid medium is adjusted by the temperature under which the liquid medium is removed from the substrate.

40. The process as claimed in claim 33, wherein the step of providing the array of nanostructures on the substrate comprises the step of interspacing adjacent nanostructures at unequal distances from each other.

41. The process as claimed in claim 33, wherein the step of providing the array of nanostructures on the substrate comprises the step of providing said nanostructures of unequal width dimensions.

42. The process as claimed in claim 33, wherein the step of providing the array of nanostructures on the substrate comprises the step of selectively etching the substrate.

43. The process as claimed in claim 42, wherein the substrate is catalytically etched.

44. The process as claimed in claim 43, comprising the step of, before the selectively etching step, depositing a plurality of catalyst particles on said substrate.

45. The process as claimed in claim 44, wherein the etching step comprises etching the substrate in contact with said catalyst particles at a faster rate relative to the substrate surface not in contact with the catalyst particles.

46. The process as claimed in claim 33, wherein the providing step comprises forming the nanostructures on the substrate using a glancing angle deposition technique.

47. The process as claimed in claim 44, wherein the catalyst particles have a dimension in the nanosize size range.

48. The process as claimed in claim 47, wherein the catalyst particles have different dimensions.

49. The process as claimed in claim 33, further comprising the step of functionalizing the nanostructures with a compound to increase the hydrophobicity of the surface of the nanostructures.

50. The process as claimed in claim 49, wherein the functionalizing step comprises functionalizing the surface of the substrate with an organosilane group.

51. The process as claimed in claim 33, wherein the dimension of said at least one nanostructure cluster is varied in order to tune the wetting property of the substrate surface.

52. The process as claimed in claim 33, comprising the step of joining another substrate having nanostructures thereon in which the longitudinal axis of said nanostructures is about normal relative to a horizontal plane of the substrate.

53. A substrate comprising at least one nanostructure cluster thereon, said nanostructure cluster comprising plural nanostructures, each nanostructure having a proximal end adjacent to said substrate and a distal end opposite to said proximal end, wherein the nanostructures of each cluster have distal ends that are spaced closer to each other relative to their respective proximal ends of said adjacent nanostructures.

54. The substrate as claimed in claim 53, wherein the distal ends of the adjacent nanostructures abut each other to form said cluster.

55. The substrate as claimed in claim 53, wherein plural clusters alter the wetting property of the substrate.

56. The substrate as claimed in claim 55, wherein the plural clusters render the substrate more hydrophobic relative to a substrate that is without the clusters.

57. The substrate as claimed in claim 53, wherein surface of the nanostructures have a hydrophobic compound thereon.

58. The substrate as claimed in claim 57, wherein the hydrophobic compound comprises an organosilane functional group.

59. The substrate as claimed in claim 53, wherein the distance between at least two pairs of nanostructures in a cluster is unequal.

60. The substrate as claimed in claim 53, wherein dimension of said at least one cluster is in the micro-size range.

61. The substrate as claimed in claim 60, wherein the at least one cluster has a dimension in the range of 1 μm to 5 μm.

62. The substrate as claimed in claim 53, wherein the distance between adjacent clusters in an array of clusters is in the range of 100 nm to 10 μm.

63. A substrate having an array of nanostructures thereon, each nanostructure having a proximal end adjacent to said substrate and a distal end opposite to said proximal end, wherein the substrate has a cluster part comprising at least one cluster of nanostructures having distal ends that are spaced closer to each other relative to the respective proximal ends of said adjacent nanostructures, and a non-cluster part comprising nanostructures having distal ends that are spaced about the same relative to the respective proximal ends of said adjacent nanostructures.

64. The substrate as claimed in claim 63, wherein plural cluster parts and non-cluster parts are provided thereon.

65. The process as claimed in claim 40, wherein the step of providing the array of nanostructures on the substrate comprises the step of providing said nanostructures of unequal width dimensions.
